(19) United States
(12) Patent Application Publication
(10) Pub. No.: US 2025/0233704 A1
(43) Pub. Date: Jul. 17, 2025

(54) METHOD AND APPARATUS FOR SENDING REFERENCE SIGNAL, AND METHOD AND APPARATUS FOR RECEIVING REFERENCE SIGNAL

(71) Applicant: Beijing Xiaomi Mobile Software Co., Ltd., Beijing (CN)

(72) Inventor: Liangang CHI, Beijing (CN)

(73) Assignee: Beijing Xiaomi Mobile Software Co., Ltd., Beijing (CN)

(21) Appl. No.: 18/855,933

(22) PCT Filed: Apr. 12, 2022
(86) PCT No.: PCT/CN2022/086461

§ 371 Date: Oct. 10, 2024

(51) Int. Cl. H04L 5/00; H04B 7/06; H04W 24/08

(52) U.S. Cl. CPC H04L 5/0048; H04B 7/06952; H04W 24/08

(57) ABSTRACT

A method, apparatus and computer readable storage medium for sending a reference signal in a wireless communication network. The reference signal sent by determining reference signal configuration information; sending the reference signal configuration information, where the reference signal configuration information is used for indicating direction information of a reference signal; and sending a corresponding reference signal on the basis of the reference signal configuration information, where the corresponding reference signal is used for indicating terminal device to perform beam measurement and/or beam management.

### CROSS-REFERENCE

The present application is a U.S. National Stage of International Application No. PCT/CN2022/086461, filed on Apr. 12, 2022, the contents of all of which are incorporated herein by reference in their entirety for all purposes.

### BACKGROUND OF THE INVENTION

As low-frequency band wireless spectrum resources are exhausted, the development and utilization of a high-frequency band millimeter wave, and even terahertz communication technology has become an inevitable trend.

### SUMMARY OF THE INVENTION

The disclosure relates to the field of communications, in particular to a reference signal sending method and apparatus, and a reference signal receiving method and apparatus.

In a first aspect, an example of the disclosure provides a method for sending a reference signal, performed by a network-side device, the method including: determining reference signal configuration information; sending the reference signal configuration information, where the reference signal configuration information is used for indicating direction information of a reference signal; and sending the reference signal based on the reference signal configuration information; where the reference signal is used for indicating a terminal device to perform beam measurement and/or beam management.

In a second aspect, an example of the disclosure provides a method for receiving reference signal, performed by a terminal device, the method including: receiving reference signal configuration information; where the reference signal configuration information is used for indicating direction information of a reference signal; determining the direction information of the reference signal according to the reference signal configuration information and a configuration mode of an index of the reference signal; and receiving the reference signal based on the direction information of the configured reference signal; where the reference signal is used for indicating the terminal device to perform beam measurement and/or beam management.

In a third aspect, an example of the disclosure provides a communication apparatus, including one or more processors and one or more memories. A computer program is stored in the one or more memories, and the computer program, when executed by the one or more processors, causes the communication apparatus to: determine reference signal configuration information; send the reference signal configuration information, where the reference signal configuration information is used for indicating direction information of a reference signal; and send a corresponding reference signal based on the reference signal configuration information; where the corresponding reference signal is used for indicating a terminal device to perform beam measurement and/or beam management.

In a fourth aspect, an example of the disclosure provides a communication apparatus, including one or more processors and one or more memories. A computer program is stored in the one or more memories, and the computer program, when executed by the one or more processors, causes the communication apparatus to perform the method according to the second aspect.

In a fifth aspect, an example of the disclosure provides a communication apparatus, including one or more processors and one or more interface circuits. The one or more interface circuits are configured to receive a code instruction and transmit the code instruction to the one or more processors. The one or more processors are configured to run the code instruction, where the code instructions cause the communication apparatus to act as the network-side device and perform the method according to the first aspect.

In a sixth aspect, an example of the disclosure provides a communication apparatus, including one or more processors and one or more interface circuits. The one or more processors are configured to run the code instruction, where the code instructions cause the communication apparatus to act as the terminal device and perform the method according to the second aspect.

In a seventh aspect, an example of the disclosure provides a non-transitory computer readable storage medium storing an instruction that when executed by the network-side device cause the network-side device to perform the method according to the first aspect.

In an eighth aspect, an example of the disclosure provides a non-transitory readable storage medium storing an instruction that when executed by the terminal device cause the terminal device to perform the method according to the second aspect.

### BRIEF DESCRIPTION OF DRAWINGS

In order to more clearly illustrate technical solutions in examples or background of the disclosure, accompanying drawings that need to be used in the examples or background of the disclosure will be described below.

FIG. 1 is a schematic architecture diagram of a communication system provided by an example of the disclosure.

FIG. 2 is a flowchart of a reference signal sending method provided by an example of the disclosure.

FIG. 3 is a flowchart of a method for determining an index of each reference signal in a configured reference signal set provided by an example of the disclosure.

FIG. 4 is a flowchart of another method for determining an index of each reference signal in a configured reference signal set provided by an example of the disclosure.

FIG. 5 is a flowchart of yet another method for determining an index of each reference signal in a configured reference signal set provided by an example of the disclosure.

FIG. 6 is a flowchart of a reference signal receiving method provided by an example of the disclosure.

FIG. 7 is a schematic structural diagram of a communication apparatus provided by an example of the disclosure;

FIG. 8 is a schematic structural diagram of another communication apparatus provided by an example of the disclosure.

### DETAILED DESCRIPTION OF THE INVENTION

Examples of the disclosure are described in detail below, and examples of the examples are shown in accompanying drawings, where the same or similar reference numerals represent the same or similar elements or elements with the same or similar functions all the time. The examples described below by reference to the accompanying drawings are examples, are intended to explain the disclosure, and cannot be construed as a limitation of the disclosure. In the description of the disclosure, unless otherwise indicated, “/” denotes the meaning of or, e.g., A/B may denote A or B. “And/or” here merely describes the association relationship of associated objects, which means that there may be three kinds of relationships, for example, A and/or B may mean that there are three kinds of situations: A alone, A and B at the same time, and B alone.

A term “include” in the specification and claims of the disclosure, as well as any its variations are intended to cover non-exclusive incorporations, e.g., a process, method, system, product, or device that incorporates a series of steps or units need not be limited to those steps or units clearly listed, but may include other steps or units that are not clearly listed or are inherent to this process, method, product, or device. In addition, in the examples of the disclosure, “exemplary” or “for example” and other words are used for meaning as an example, illustration, or description. Any example or design solution described as “exemplary” or “for example” in the examples of the disclosure is not to be construed as preferred or advantageous over other examples or design solutions. Rather, the use of “exemplary” or “for example” and other words is intended to present relevant concepts in a concrete mode.

In the related art, the use of a narrow beam for data transmission is needed in order to cope with the challenge of a road loss faced by high-frequency band millimeter wave and terahertz communications. However, in a mobile communication scenario, how to realize accurate alignment, and real-time tracking and updating of the narrow beam has become a problem that needs to be solved urgently.

Examples of the disclosure provide a reference signal sending method and apparatus, and a reference signal receiving method and apparatus. By sending beam information of a reference signal, a terminal device can be assisted to better perform beam measurement, a beam prediction, and beam management, so that a capability of the terminal device for the beam measurement and the beam management may be improved, thus accurate alignment, and real-time tracking and updating of a narrow beam may be realized.

In order to better understand a reference signal sending method and apparatus, and a reference signal receiving method and apparatus disclosed by examples of the disclosure, a communication system used in the example of the disclosure is first described below.

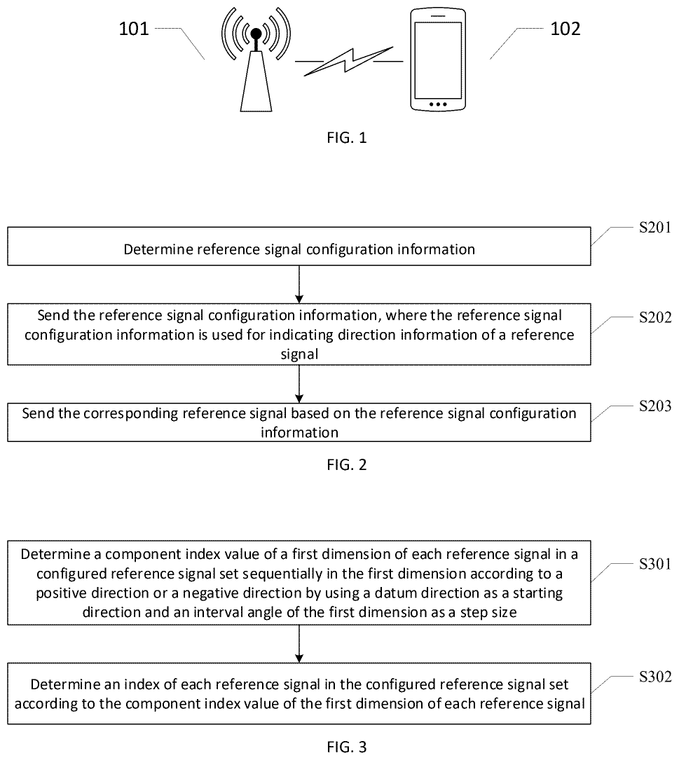

Please refer to FIG. 1. FIG. 1 is a schematic architecture diagram of a communication system 100 provided by an example of the disclosure. Taking the communication system 100 shown in FIG. 1 as an example, the communication system 100 may include but is not limited to a network-side device 101 and a terminal device 102. The number and forms of devices shown in FIG. 1 are merely for example and do not constitute a limitation of the example of the disclosure, and two or more network-side devices 101 and two or more terminal devices 102 may be included in actual applications.

It needs to be noted that the technical solution of the example of the disclosure may be applied to various communication systems, for example, a long term evolution (LTE) system, a 5th generation (5G) mobile communication system, a 5G new radio (NR) system, or other novel mobile communication systems in the future.

The network-side device 101 in the example of the disclosure is an entity on a network side and used for transmitting or receiving a signal. For example, the network-side device 101 may be an evolved NodeB (eNB), a transmission reception point (TRP), a next generation NodeB (gNB) in an NR system, a base station in other future mobile communication systems, or an access node in a wireless fidelity (WiFi) system, etc. A specific technology and specific device form adopted for the network-side device 101 are not limited by the example of the disclosure. The network-side device 101 provided by the example of the disclosure may be composed of a central unit (CU) and a distributed unit (DU), where the CU may also be referred to as a control unit. Adopting a CU-DU structure may divide a protocol layer of a data sending end, e.g., the data sending end may include the base station. A function of part of the protocol layer is placed in the CU for central control. A function of part or all of the rest of the protocol layer is distributed in the DU, and the DU is centrally controlled by the CU.

The terminal device 102 in the example of the disclosure is an entity on a user side and used for receiving or transmitting a signal, such as a mobile phone. A data receiving end may also be called a terminal, user equipment (UE), a mobile station (MS), a mobile terminal (MT), etc. The data receiving end may be a car with a communication function, a smart car, a mobile phone, a wearable device, a pad, a computer with a wireless receive-send function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc.

It may be understood that the communication system 100 described in the example of the disclosure is to more clearly illustrate the technical solution of the example of the disclosure, and does not constitute a limitation on the technical solution provided by the example of the disclosure. It may be known to those ordinarily skilled in the art that with the evolution of a system architecture and the emergence of new service scenarios, the technical solution provided by the example of the disclosure is also suitable for similar technical problems.

Please refer to FIG. 2. FIG. 2 is a flowchart of a reference signal sending method provided by an example of the disclosure. The method is performed by a network-side device. As shown in FIG. 2, the reference signal sending method may include but is not limited to the steps S201, S202 and S203.

In step S201, reference signal configuration information is determined.

The reference signal configuration information in the disclosure may be understood as configuration information of a reference signal configured by the network-side device. The configuration information may be used for characterizing beam information of the reference signal configured by the network-side device. For example, the reference signal may be configured by the network-side device, where the configured reference signal may be represented by a set. The reference signal set may have one or more reference signals configured by the network-side device. The network-side device may determine the reference signal configuration information after the configuration of the reference signal is completed.

In some examples of the disclosure, the reference signal configuration information includes at least one of the following: an index of each reference signal in a configured reference signal set; an index of a configured datum reference signal; a beam width of each reference signal in the configured reference signal set; or an interval angle between sending beams of reference signals of adjacent indexes in the configured reference signal set.

In an implementation, the index of each reference signal may be represented by one index value, for example, by i. Or, the index of each reference signal may be represented by two component index values respectively, for example, by (m, n).

In an implementation, the index of the configured datum reference signal may be represented by one index value, for example, by i₀. Or, the index of the configured datum reference signal may be represented by two component index values respectively, for example, by (m₀, n₀).

In an implementation, the beam width may be understood as an included angle between two beam boundaries. The beam width of each reference signal may be understood as an included angle between beam boundaries of sending beams of reference signals of two adjacent indexes. In the example of the disclosure, a beam boundary is defined as a beam direction that attenuates a preset decibel (e.g., 3 dB) relative to a direction of strongest energy of a corresponding beam.

In an implementation, an example is taken that the two sending beams corresponding to the two reference signals of the adjacent indexes are beam 1 and beam 2, and then the interval angle between the sending beams of the reference signals of the adjacent indexes may be an angle between a left boundary of beam 1 and a right boundary of beam 2 in the adjacent beams, may further be an angle between a right boundary of beam 1 and a left boundary of beam 2, or, may further be an angle between a left boundary of beam 1 and a left boundary of beam 2, or, may further be an angle between a right boundary of beam 1 and a right boundary of beam 2, as may be determined according to actual applications.

In an optional implementation, the interval angle may include an interval angle of a first dimension and/or an interval angle of a second dimension. It may be understood that when the sending beam of the reference signal is a beam in the first dimension, then the interval angle is the interval angle of the first dimension. When the sending beam of the reference signal is a beam in the second dimension, the interval angle is the interval angle of the second dimension. When the sending beam of the reference signal is a two-dimensional beam, the interval angle includes the interval angle of the first dimension and the interval angle of the second dimension.

The interval angle of the first dimension may be an interval angle of a center of the beam in the first dimension, and the interval angle of the second dimension may be an interval angle of a center of a beam in the second dimension. Or, the interval angle of the first dimension may be an interval angle of a boundary of the beam in the first dimension, and the interval angle of the second dimension may be an interval angle of a boundary of the beam in the second dimension.

That is, a mode of determining the interval angle may include the following two modes: mode 1, the interval angle of the center of the beam, i.e., an interval angle of a direction in which beam energy is strongest; and mode 2, the interval angle of the boundary of the beam.

It needs to be noted that in the example of the disclosure, the first dimension refers to a horizontal dimension or a vertical dimension, and the second dimension refers to the other dimension of the horizontal dimension and the vertical dimension that is different from the first dimension. For example, the first dimension may be the horizontal dimension, and the second dimension may be the vertical dimension. For another example, the first dimension may be the vertical dimension, and the second dimension may be the horizontal dimension.

In step S202, the reference signal configuration information is sent. The reference signal configuration information is used for indicating direction information of a reference signal.

In step S203, the corresponding reference signal is sent based on the reference signal configuration information.

In some examples of disclosure, the corresponding reference signal is used to indicate a terminal device that performs beam measurement and/or beam management.

For example, the corresponding reference signal is sent to the terminal device by the network-side device using a corresponding sending beam based on the reference signal configuration information. The reference signal configuration information sent by the network-side device may be received by the terminal device, and the direction information of the reference signal configured by the network-side device is determined according to the reference signal configuration information and/or a configuration mode of an index of a reference signal, and the corresponding reference signal is received based on the direction information to complete the beam measurement and/or the beam management based on the received reference signal. As an example, a beam prediction, beam management and reporting based on artificial intelligence (AI)/machine learning (ML) may be completed by the terminal device using the received reference signal.

In an implementation, in a direction of the reference signal contained in the reference signal configuration information sent to the terminal device, the corresponding reference signal may be sent to the terminal device by the network-side device. The reference signal is used for indicating the terminal device to perform the beam measurement.

In an implementation, in the direction of the reference signal contained in the reference signal configuration information sent to the terminal device, the corresponding reference signal may be sent to the terminal device by the network-side device. The reference signal is used for indicating the terminal device to perform the beam management.

In an implementation, in the direction of the reference signal contained in the reference signal configuration information sent to the terminal device, the corresponding reference signal may be sent to the terminal device by the network-side device. The reference signal is used to indicate the terminal device that will perform the beam measurement and the beam management.

By implementing the example of the disclosure, the reference signal configuration information is determined and sent to the terminal device, such that the terminal device determines, based on the configuration information, the direction information of the reference signal, which is configured by the network-side device, and thus the terminal device receives the corresponding reference signal based on the direction, to complete the beam measurement and/or the beam management based on the reference signal. It may be seen that in the disclosure, by sending beam information of the reference signal to the terminal device, the terminal device can be assisted to better perform the beam measurement, the beam prediction, and the beam management, so that a capability of the terminal device for the beam measurement and the beam management may be improved, and thus accurate alignment and real-time tracking and updating of a narrow beam may be realized.

It needs to be noted that the reference signal configuration information in the disclosure is configuration information determined after the reference signal is configured by the network-side device. The index of each reference signal in the reference signal configuration information may be determined based on the configuration mode of an index of a reference signal. That is, in the disclosure, the index of each reference signal in the reference signal set configured by the network-side device may be determined based on the configuration mode of an index of a reference signal. It may be understood that the sending beam of the reference signal may be a one-dimensional beam, or may further be a two-dimensional beam, i.e., a possible difference in the configuration mode of an index of a reference signal is resulted by a difference in the dimensions of the sending beam of the reference signal. In the following, an implementation mode of determining the index of each reference signal in the reference signal configuration information will be introduced respectively in conjunction with FIG. 3 to FIG. 5 from the different dimensions of the sending beam of the reference signal.

In some examples of the disclosure, please refer to FIG. 3, and FIG. 3 is a flowchart of a method for determining an index of each reference signal in a configured reference signal set provided by an example of the disclosure. When a beam of a reference signal in a reference signal set is a one-dimensional beam, and the sending beam is a beam in a first dimension (e.g., a horizontal dimension), the method may be adopted for determining the index of each reference signal in the configured reference signal set. As shown in FIG. 3, the method for determining the index of each reference signal in the configured reference signal set may include but is not limited to the steps S301 and S302.

In step S301, a component index value of the first dimension of each reference signal in the configured reference signal set is determined sequentially in the first dimension according to a positive direction or a negative direction by using a datum direction as a starting direction and the interval angle of the first dimension as a step size.

In the example of the disclosure, the interval angle of the first dimension may be an interval angle of a center of a beam in the first dimension. Or, the interval angle of the first dimension may be an interval angle of a boundary of the beam in the first dimension.

For example, an example is taken that the interval angle of the first dimension is the interval angle of the center of the beam in the first dimension, the datum direction may be used as a starting direction, the interval angle of the center of the beam in the first dimension may be used as a step size, a preset position of a certain reference signal (e.g., a direction in which beam energy of the reference signal is strongest) is reached after m step sizes in the first dimension according to a specified positive direction or negative direction, then m is the component index value of the first dimension of the reference signal, and a maximum value of m is a value obtained by dividing 360° by the interval angle of the first dimension.

It needs to be noted that the change of a magnitude of the index value varies with different directions of rotation. In some examples of disclosure, a rule for changing the magnitude of the index value with the direction of rotation may be preset. For example, it may be preset that the index value gradually becomes larger during rotation according to a positive direction, and the index value gradually becomes smaller during rotation according to a negative positive direction. Or, it may be preset that the index value gradually becomes smaller during rotation according to the positive direction, and the index value gradually becomes larger during rotation according to the negative positive direction. The rule of the change of the magnitude of the index value with the direction of rotation may be decided according to an actual application, which is not specifically limited by the disclosure.

As an example, an example is taken that the index value gradually becomes larger during rotation according to the positive direction, and the index value gradually becomes smaller during rotation according to the negative positive direction, the number of reference signals in the reference signal set configured by the network-side device is determined to be 10, and then the number of indexes of the configured reference signals is also 10. An example is taken that a first index number is 0, it is assumed that the reference direction is used as the starting direction, and the interval angle of the center of the beam in the first dimension is used as the step size, and a reference signal is reached after rotation in the positive direction for two step sizes in the first dimension, and then the index value of the reference signal is 2. Another reference signal is reached after rotation in the negative direction for two step sizes, and then the index value of the reference signal is 8.

As another example, an example is taken that the index value gradually becomes smaller during rotation according to the positive direction, and the index value gradually becomes larger during rotation according to the negative positive direction, the number of reference signals in the reference signal set configured by the network-side device is determined to be 10, and then the number of indexes of the configured reference signals is also 10. An example is taken that a first index number is 0, it is assumed that the reference direction is used as the starting direction, and the interval angle of the center of the beam in the first dimension is used as the step size, and a reference signal is reached after rotation in the positive direction for two step sizes in the first dimension, and then the index value of the reference signal is 8. Another reference signal is reached after rotation in the negative direction for two step sizes, and then the index value of the reference signal is 2.

In an optional implementation, the datum direction may be a beam direction of the configured datum reference signal; or, the datum direction may be a preset absolute direction.

For example, the beam direction of the datum reference signal configured by the network-side device may be used as the datum direction, or, an absolute direction may be preset as the datum direction; e.g., a due north direction in a horizontal dimension is set as the datum direction, and a zenith direction in a vertical dimension is set as the datum direction.

In step S302, the index of each reference signal in the configured reference signal set is determined according to the component index value of the first dimension of each reference signal.

In an optional implementation, determining the index of each reference signal in the configured reference signal set according to the component index value of the first dimension of each reference signal includes: determining the component index value of the first dimension of each reference signal as the index of each reference signal.

For example, the component index value of the first dimension of each reference signal may be directly used as the index of the corresponding reference signal.

By implementing the example of the disclosure, when the sending beam of the reference signal in the reference signal set is a one-dimensional beam, and the sending beam is the beam in the first dimension (e.g., a horizontal dimension), a component index value of the first dimension of each reference signal in the configured reference signal set is determined sequentially in the first dimension according to a positive direction or a negative direction by using a datum direction as a starting direction and the interval angle of the first dimension as a step size, so that an index of a configured reference signal may be realized.

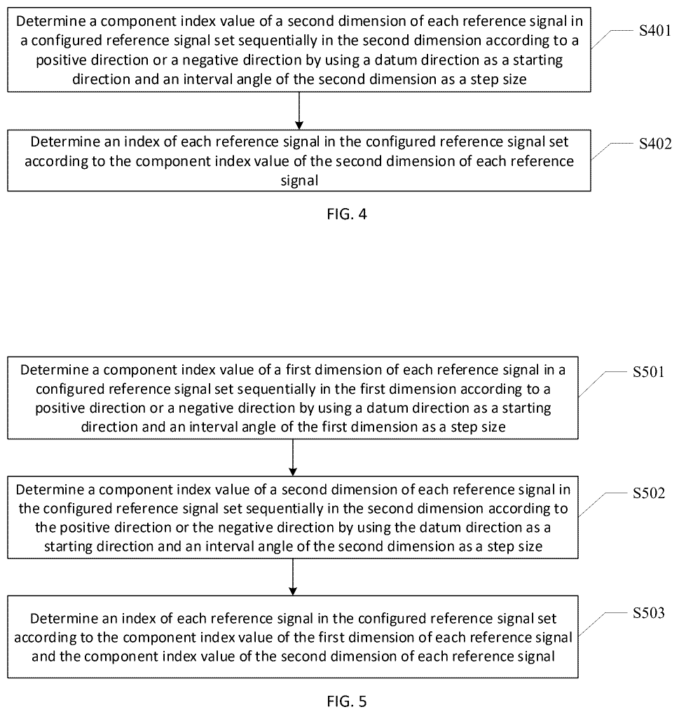

In some examples of the disclosure, please refer to FIG. 4, and FIG. 4 is a flowchart of another method for determining an index of each reference signal in a configured reference signal set provided by an example of the disclosure. When a beam of a reference signal in the reference signal set is a one-dimensional beam, and the sending beam is a beam in a second dimension (e.g., a vertical dimension), the method may be adopted for determining the index of each reference signal in the configured reference signal set. As shown in FIG. 4, the method for determining the index of each reference signal in the configured reference signal set may include but is not limited to the steps S401 and S402.

In step S401, a component index value of the second dimension of each reference signal in the configured reference signal set is determined sequentially in the second dimension according to a positive direction or a negative direction by using a datum direction as a starting direction and an interval angle of the second dimension as a step size.

In the example of the disclosure, the interval angle of the second dimension may be an interval angle of a center of a beam in the second dimension. Or, the interval angle of the second dimension may be an interval angle of a boundary of the beam in the second dimension.

For example, an example is taken that the interval angle of the second dimension is the interval angle of the center of the beam in the second dimension, the preset datum direction is used as a starting direction, the interval angle of the center of the beam in the second dimension is used as a step size, a preset position of a certain reference signal (e.g., a direction in which beam energy of the reference signal is strongest) is reached after n step sizes in the second dimension according to a specified positive direction or negative direction, then n is the component index value of the second dimension of the reference signal, and a maximum value of n is a value obtained by dividing 360° by the interval angle of the second dimension.

It needs to be noted that the change of a magnitude of the index value varies with different directions of rotation. In some examples of disclosure, a rule for changing the magnitude of the index value with the direction of rotation may be preset. For example, it may be preset that the index value gradually becomes larger during rotation according to a positive direction, and the index value gradually becomes smaller during rotation according to a negative positive direction. Or, it may be preset that the index value gradually becomes smaller during rotation according to the positive direction, and the index value gradually becomes larger during rotation according to the negative positive direction. The rule of the change of the magnitude of the index value with the direction of rotation may be decided according to an actual application, which is not specifically limited by the disclosure. The implementation of the component index value of the second dimension of the reference signal is similar to the implementation of the component index value of the first dimension of the reference signal in the example shown in FIG. 3 above, and may refer to the description of the implementation of the component index value of the first dimension of the reference signal in the example shown in FIG. 3 above, which will not be repeated here.

In an optional implementation, the datum direction may be a beam direction of the configured datum reference signal; or, the datum direction may be a preset absolute direction.

For example, the beam direction of the datum reference signal configured by the network-side device may be used as the datum direction, or, an absolute direction may be preset as the datum direction; e.g., a due north direction in a horizontal dimension is set as the datum direction, and a zenith direction in a vertical dimension is set as the datum direction.

In step S402, the index of each reference signal in the configured reference signal set is determined according to the component index value of the second dimension of each reference signal.

In an optional implementation, determining the index of each reference signal in the configured reference signal set according to the component index value of the second dimension of each reference signal includes: determining the component index value of the second dimension of each reference signal as the index of each reference signal.

For example, the component index value of the second dimension of each reference signal may be directly used as the index of each corresponding reference signal.

By implementing the example of the disclosure, when the sending beam of the reference signal in the reference signal set is a one-dimensional beam, and the sending beam is the beam in the second dimension (e.g., a vertical dimension), a component index value of the second dimension of each reference signal in the configured reference signal set may be determined sequentially in the second dimension according to a positive direction or a negative direction by using a datum direction as a starting direction and the interval angle of the second dimension as a step size, so that an index of a configured reference signal may be realized.

In some examples of the disclosure, please refer to FIG. 5, and FIG. 5 is a flowchart of yet another method for determining an index of each reference signal in a configured reference signal set provided by an example of the disclosure. When a beam of a reference signal in the reference signal set is a two-dimensional beam, the method may be adopted for determining the index of each reference signal in the configured reference signal set. As shown in FIG. 5, the method for determining the index of each reference signal in the configured reference signal set may include but is not limited to the steps S501, S502, and S503.

In step S501, a component index value of the first dimension of each reference signal in the configured reference signal set is determined sequentially in the first dimension according to a positive direction or a negative direction by using a datum direction as a starting direction and the interval angle of the first dimension as a step size,

In the example of the disclosure, step S501 may be implemented by adopting any mode of the various examples of the disclosure respectively, which is not limited by the example of the disclosure and will not be repeated.

In step S502, a component index value of the second dimension of each reference signal in the configured reference signal set is determined sequentially in the second dimension according to a positive direction or a negative direction by using a datum direction as a starting direction and an interval angle of the second dimension as a step size.

In the example of the disclosure, step S502 may be implemented by adopting any mode of the various examples of the disclosure respectively, which is not limited by the example of the disclosure and will not be repeated.

It needs to be noted that in the example of the disclosure, the direction according to which the component index value of the first dimension of the reference signal is determined in the first dimension and the direction according to which the component index value of the second dimension of the reference signal is determined in the second dimension may be the same or different.

As an example, a component index value of the first dimension of each reference signal in the configured reference signal set may be determined sequentially in the first dimension according to a positive direction by using a datum direction of the first dimension as a starting direction and the interval angle of the first dimension as a step size, and a component index value of the second dimension of each reference signal in the configured reference signal set is determined sequentially in the second dimension according to a negative direction by using a datum direction of the second dimension as a starting direction and an interval angle of the second dimension as a step size.

As an example, a component index value of the first dimension of each reference signal in the configured reference signal set may be determined sequentially in the first dimension according to a positive direction by using a datum direction of the first dimension as a starting direction and the interval angle of the first dimension as a step size, and a component index value of the second dimension of each reference signal in the configured reference signal set is determined sequentially in the second dimension according to a positive direction by using a datum direction of the second dimension as a starting direction and an interval angle of the second dimension as a step size.

As an example, a component index value of the first dimension of each reference signal in the configured reference signal set may be determined sequentially in the first dimension according to a negative direction by using a datum direction of the first dimension as a starting direction and the interval angle of the first dimension as a step size, and a component index value of the second dimension of each reference signal in the configured reference signal set is determined sequentially in the second dimension according to a negative direction by using a datum direction of the second dimension as a starting direction and an interval angle of the second dimension as a step size.

As another example, a component index value of the first dimension of each reference signal in the configured reference signal set may be determined sequentially in the first dimension according to a negative direction by using a datum direction of the first dimension as a starting direction and the interval angle of the first dimension as a step size, and a component index value of the second dimension of each reference signal in the configured reference signal set is determined sequentially in the second dimension according to a positive direction by using a datum direction of the second dimension as a starting direction and an interval angle of the second dimension as a step size.

In step S503, the index of each reference signal in the configured reference signal set is determined according to the component index value of the first dimension of each reference signal and the component index value of the second dimension of each reference signal.

In an optional implementation, the component index value of the first dimension of each reference signal and the component index value of the second dimension of each reference signal may be used as the index of each reference signal. Or, the index of each reference signal may be generated according to the component index value of the first dimension of each reference signal and the component index value of the second dimension of each reference signal.

For example, an example is taken that the index of the reference signal is expressed by two component index values, the component index value of the first dimension of each reference signal and the component index value of the second dimension of each reference signal may be directly used as the index of each corresponding reference signal. For example, an example is taken that a component index value of a first dimension of a certain reference signal is m and a component index value of a second dimension of the reference signal is n, and the component index value of the first dimension of the reference signal and the component index value of the second dimension of the reference signal may be directly used as two components of the index of the reference signal, i.e., the index of the reference signal is (m, n), i.e., expressed by two component index values.

For another example, an example is taken that the index of the reference signal is expressed by one index value, and the index of each reference signal may be generated using a preset generating function according to a component index value of the first dimension of each reference signal and a component index value of the second dimension of each reference signal.

In an implementation, the index of each reference signal is generated according to the component index value of the first dimension of each reference signal, the number of beams in the first dimension, and the component index value of the second dimension of each reference signal. Or, the index of each reference signal is generated according to the component index value of the first dimension of each reference signal, the component index value of the second dimension of each reference signal, and the number of beams in the second dimension.

As an example, a formula (1) for a generating function used for generating the index of each reference signal according to the component index value of the first dimension of each reference signal, the number of beams in the first dimension, and the component index value of the second dimension of each reference signal may be expressed as follows:

$$i = m + nM \qquad ( 1 )$$

where i is an index of a reference signal, m is a component index value of a first dimension of each reference signal, M is the number of beams in the first dimension, and n is a component index value of a second dimension of each reference signal, and, as an example, m and n may start from an index number 0 respectively.

As another example, a formula (2) for a generating function used for generating the index of each reference signal according to the component index value of the first dimension of each reference signal, the component index value of the second dimension of each reference signal, and the number of beams in the second dimension may be expressed as follows:

$$i = mN + n \qquad ( 2 )$$

where i is an index of a reference signal, m is a component index value of a first dimension of each reference signal, N is the number of beams in the second dimension, and n is a component index value of a second dimension of each reference signal, and, as an example, m and n may start from an index number 0 respectively.

By implementing the example of the disclosure, when the sending beam of the reference signal in the reference signal set is a two-dimensional beam, component index values of the first dimension and the second dimension of each reference signal in the configured reference signal set may be determined sequentially in the first dimension and the second dimension according to a positive direction or a negative direction by using datum directions of the first dimension as starting directions and the interval angles of the first dimension and the second dimension as step sizes, so that the index of the configured reference signal may be realized.

In some examples of the disclosure, the reference signal sending method may further include: determining a configuration mode of an index of a reference signal, where the configuration mode of an index of a reference signal is a configuration mode adopted when the index of each reference signal is configured. The reference signal configuration information may further include the configuration mode of an index of a reference signal.

It may be understood that the configuration mode of an index of a reference signal in the disclosure may be agreed by a protocol. Or, the configuration mode of an index of a reference signal may be preset. In the examples of the disclosure, when the configuration mode of an index of a reference signal is agreed by a protocol, the index of each reference signal may be determined by the network-side device based on the configuration mode agreed by the protocol, when the reference signal configuration information is sent to the terminal device, there is no need to send the configuration mode of an index of a reference signal to the terminal device, and the terminal device can perform corresponding processing based on the configuration mode of an index of a reference signal agreed by the protocol after receiving the reference signal configuration information. When the configuration mode of an index of a reference signal is preset, the configuration mode of an index of a reference signal further needs to be sent to the terminal device by the network-side device. For example, the reference signal configuration information sent to the terminal device by the network-side device may also include the configuration method adopted when the index of each reference signal is configured.

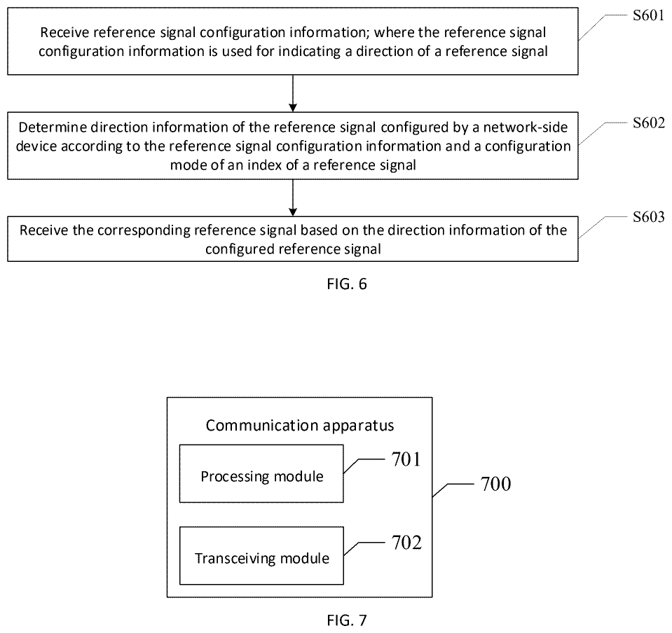

Please refer to FIG. 6. FIG. 6 is a flowchart of a reference signal receiving method provided by an example of the disclosure. The method is performed by a terminal device. As shown in FIG. 6, the reference signal receiving method may include but is not limited to the steps S601, S602, and S603.

In step S601, reference signal configuration information is received. The reference signal configuration information is used for indicating direction information of a reference signal.

In some examples of the disclosure, the reference signal configuration information may be sent by a network-side device.

In some examples of the disclosure, the reference signal configuration information includes at least one of the following: an index of each reference signal in a configured reference signal set; an index of a configured datum reference signal; a beam width of each reference signal in the configured reference signal set; or an interval angle between sending beams of reference signals of adjacent indexes in the configured reference signal set.

In an implementation, the index of each reference signal may be represented by one index value, for example, by i. Or, the index of each reference signal may be represented by two component index values respectively, for example, by (m, n).

In an implementation, the index of the configured datum reference signal may be represented by one index value, for example, by i₀. Or, the index of the configured datum reference signal may be represented by two component index values respectively, for example, by (m₀, n₀).

In an implementation, the beam width may be understood as an included angle between two beam boundaries. The beam width of each reference signal may be understood as an included angle A between beam boundaries of sending beams of two reference signals of adjacent indexes.

In an optional implementation, the interval angle may include an interval angle of a first dimension and/or an interval angle of a second dimension. It may be understood that when the beam of the reference signal is a beam in the first dimension, then the interval angle is the interval angle of the first dimension. When the beam of the reference signal is a beam in the second dimension, then the interval angle is the interval angle of the second dimension. When the beam of the reference signal is a two-dimensional beam, then the interval angle includes the interval angle of the first dimension and the interval angle of the second dimension.

The interval angle of the first dimension may be an interval angle of a center of the beam in the first dimension, and the interval angle of the second dimension may be an interval angle of a center of a beam in the second dimension. Or, the interval angle of the first dimension may be an interval angle of a boundary of the beam in the first dimension, and the interval angle of the second dimension may be an interval angle of a boundary of the beam in the second dimension.

That is, a mode of determining the interval angle may include the following two modes: mode 1, the interval angle of the center of the beam, i.e., an interval angle of a direction in which beam energy is strongest; and mode 2, the interval angle of the boundary of the beam.

In step S602, the direction information of the reference signal is determined according to the reference signal configuration information and a configuration mode of an index of a reference signal.

For example, a component index value of each dimension of the reference signal configured by the network-side device may be determined based on the received reference signal configuration information and the configuration mode of an index of a reference signal, and a direction of strongest energy and/or a beam width of the reference signal may be obtained based on the respective component index value of the reference signal and a corresponding pairwise interval angle.

As an example, an example is taken that the sending beam of the reference signal is a one-dimensional beam, it is assumed that the index value of the reference signal is 2 and the interval angle is 10°, and the direction in which the beam energy of the reference signal is the strongest is the direction that is offset by 2×10°=20° in a specified direction in which an index value increases by using the datum direction as a starting angle.

As another example, an example is taken that the sending beam of the reference signal is a two-dimensional beam, it is assumed that the index value of the reference signal is (2, 3), and the interval angle is 100 (e.g., an interval angle of a center of a beam in the first dimension) and 15° (e.g., an interval of a center of a beam in the second dimension), and then the direction in which the beam energy in the first dimension of the reference signal is the strongest is a direction that is offset by 2×10°=20° in a specified direction in which an index value of the first dimension increases by using the datum direction of the first dimension as a starting angle. The direction in which the beam energy in the second dimension of the reference signal is the strongest is a direction that is offset by 3×15°=45° in a specified direction in which an index value of the second dimension increases by using the datum direction of the second dimension as a starting angle.

In an implementation, the configuration mode of an index of a reference signal is a configuration mode agreed by a protocol; or, the configuration mode of an index of a reference signal is contained in the received reference signal configuration information.

It may be understood that the configuration mode of an index of a reference signal in the example of the disclosure may be agreed by a protocol. Or, the configuration mode of an index of a reference signal may be preset. In the example of the disclosure, when the configuration mode of an index of a reference signal is agreed by a protocol, the index of each reference signal may be determined by the terminal device based on the configuration mode agreed by the protocol, and when the reference signal configuration information sent by the network-side device is received, corresponding processing is performed based on the configuration mode of an index of a reference signal agreed by the protocol. When the configuration mode of an index of a reference signal is preset, the terminal device needs to determine from the received reference signal configuration information the configuration mode of an index of a reference signal, i.e., the configuration mode adopted when the index of each reference signal is configured.

In step S603, the corresponding reference signal is received based on the direction information of the configured reference signal.

The corresponding reference signal is used for indicating the terminal device to perform beam measurement and/or beam management.

For example, the reference signal is received based on the direction information of the configured reference signal in an angular direction corresponding to the direction information. As an example, a beam prediction, beam management and reporting based on AI/ML may be completed by the terminal device using the received reference signal.

In the example of the disclosure, the reference signal may be sent by a network-side device that sends the reference signal configuration information, or, may be sent by other devices (e.g., another network-side device).

As an example, the terminal device may receive reference signal configuration information sent by a network-side device A, and based on the reference signal configuration information, receive a reference signal sent by a network-side device B in a corresponding angular direction.

By implementing the example of the disclosure, the reference signal configuration information sent by the network-side device may be received by the terminal device, the direction information of the reference signal configured by the network-side device is determined based on the configuration information, and the corresponding reference signal is received based on the direction, so that the beam measurement and/or the beam management is completed based on the reference signal. It may be seen that the beam information of the reference signal configured by the network-side device may be determined by the terminal device in the disclosure based on the received reference signal configuration information, thus the beam measurement, the beam prediction, and the beam management may be better performed, so that a capability of the terminal device for the beam measurement and the beam management may be improved, and thus accurate alignment and real-time tracking and updating of a narrow beam may be realized.

Please refer to FIG. 7 which is a schematic structural diagram of a communication apparatus 700 provided by an example of the disclosure. The communication apparatus 700 shown in FIG. 7 may include a transceiving module 702 and a processing module 701. The transceiving module 702 may include a sending module and/or a receiving module, the transmitting module is configured to implement a sending function, the receiving module is configured to implement a receiving function, and the transceiving module 702 may implement a sending function and/or a receiving function.

The communication apparatus 700 may be a terminal device, or an apparatus in a terminal device, or an apparatus capable of being used in conjunction with a terminal device. Or, the communication apparatus 700 may be a network-side device, or an apparatus in a network-side device, or an apparatus capable of being used in conjunction with a network-side device.

The communication apparatus 700 is a network-side device. In the example of the disclosure, the processing module 701 is configured to determine reference signal configuration information. The transceiving module 702 is configured to send the reference signal configuration information. The reference signal configuration information is used for indicating direction information of a reference signal. The transceiving module 702 is further configured to send the corresponding reference signal based on the reference signal configuration information, where the corresponding reference signal is used to indicate a terminal device to perform beam measurement and/or beam management.

In an implementation, the reference signal configuration information at least includes at least one of the following: an index of each reference signal in a configured reference signal set; an index of a configured datum reference signal; a beam width of each reference signal in the configured reference signal set; or an interval angle between sending beams of reference signals of adjacent indexes in the configured reference signal set.

In an optional implementation, the interval angle includes an interval angle of a first dimension and/or an interval angle of a second dimension. The interval angle of the first dimension is an interval angle of a center of a beam in the first dimension, and the interval angle of the second dimension is an interval angle of a center of a beam in the second dimension. Or, the interval angle of the first dimension is an interval angle of a boundary of the beam in the first dimension, and the interval angle of the second dimension is an interval angle of a boundary of the beam in the second dimension.

In an optional implementation, the processing module 701 is specifically configured to: determine a component index value of the first dimension of each reference signal in the configured reference signal set sequentially in the first dimension according to a positive direction or a negative direction by using a datum direction as a starting direction and the interval angle of the first dimension as a step size; and/or, determine a component index value of the second dimension of each reference signal in the configured reference signal set sequentially in the second dimension according to the positive direction or the negative direction by using the datum direction as a starting direction and the interval angle of the second dimension as a step size; and determine the index of each reference signal in the configured reference signal set according to the component index value of the first dimension of each reference signal and/or the component index value of the second dimension of each reference signal.

Alternatively, the datum direction is a beam direction of the configured datum reference signal; or, the datum direction is a preset absolute direction.

Alternatively, when a sending beam of each reference signal is a one-dimensional beam, the processing module 701 is specifically configured to: determine the component index value of the first dimension of each reference signal or the component index value of the second dimension of each reference signal as the index of each reference signal.

Alternatively, when the sending beam of each reference signal is a two-dimensional beam, the processing module 701 is specifically configured to: determine the component index value of the first dimension of each reference signal and the component index value of the second dimension of each reference signal as the index of each reference signal; or, generate the index of each reference signal according to the component index value of the first dimension of each reference signal and the component index value of the second dimension of each reference signal.

Alternatively, the processing module 701 is specifically configured to: generate the index of each reference signal according to the component index value of the first dimension of each reference signal, the number of beams in the first dimension, and the component index value of the second dimension of each reference signal; or, generate the index of each reference signal according to the component index value of the first dimension of each reference signal, the component index value of the second dimension of each reference signal, and the number of beams in the second dimension.

In an optional implementation, the processing module 701 is further configured to determine a configuration mode of an index of a reference signal. The configuration mode of an index of a reference signal is a configuration mode adopted when the index of each reference signal is configured. The reference signal configuration information further includes the configuration mode of an index of a reference signal.

With the communication apparatus of the example of the disclosure, the reference signal configuration information is determined and sent, such that after receiving the configuration information, the terminal device determines, based on the configuration information, the direction information of the reference signal, and thus the terminal device receives the corresponding reference signal based on the direction, to complete the beam measurement and/or the beam management based on the reference signal. It may be seen that in the disclosure, by sending beam information of the reference signal, the terminal device can be assisted to better perform the beam measurement, the beam prediction, and the beam management, so that a capability of the terminal device for the beam measurement and the beam management may be improved, and thus accurate alignment and real-time tracking and updating of a narrow beam may be realized.

The communication apparatus 700 is a terminal device. In the example of the disclosure, the transceiving module 702 is configured to receive reference signal configuration information. The reference signal configuration information is used for indicating direction information of a reference signal. The processing module 701 is configured to determine the direction information of the reference signal according to the reference signal configuration information and a configuration mode of an index of a reference signal. The transceiving module 702 is further configured to receive the corresponding reference signal based on the direction information of the configured reference signal, where the corresponding reference signal is used to indicate a terminal device to perform beam measurement and/or beam management.

In an implementation, the reference signal configuration information at least includes at least one of the following: an index of each reference signal in a configured reference signal set; an index of a configured datum reference signal; a beam width of each reference signal in the configured reference signal set; or an interval angle between sending beams of reference signals of adjacent indexes in the configured reference signal set.

In an optional implementation, the interval angle of the first dimension is an interval angle of a center of a beam in the first dimension, and the interval angle of the second dimension is an interval angle of a center of a beam in the second dimension. Or, the interval angle of the first dimension is an interval angle of a boundary of the beam in the first dimension, and the interval angle of the second dimension is an interval angle of a boundary of the beam in the second dimension.

In an implementation, the configuration mode of an index of a reference signal is a configuration mode agreed by a protocol; or, the configuration mode of an index of a reference signal is contained in reference signal configuration information.

With the communication apparatus of the example of the disclosure, the reference signal configuration information sent by the network-side device may be received by the terminal device, the direction information of the reference signal configured by the network-side device is determined based on the configuration information, and the corresponding reference signal is received based on the direction, so that beam measurement and/or beam management is completed based on the reference signal. It may be seen that the beam information of the reference signal may be determined by the terminal device in the disclosure based on the received reference signal configuration information, the terminal device may be assisted to better perform the beam measurement, the beam prediction, and the beam management, so that a capability of the terminal device for the beam measurement and the beam management may be improved, and thus accurate alignment and real-time tracking and updating of a narrow beam may be realized.

As for the apparatus in the example, a specific mode in which each module executes operations has been described in detail in the examples of the method, which will not be described in detail here.

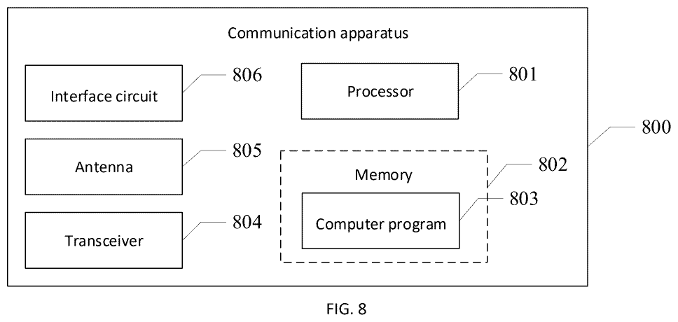

Please refer to FIG. 8. FIG. 8 is a schematic structural diagram of a communication apparatus 800 provided by an example of the disclosure. The communication apparatus 800 may be a network-side device, may further be a chip, a chip system, or a processor, etc., that supports the network-side device to implement the method, and may further be a chip, a chip system, or a processor, etc., that supports a terminal device to implement the method. The communication apparatus may be used to implement the methods described in the method examples, which may refer to the description in the method examples for details.

The communication apparatus 800 may be a terminal device, may further be a chip, a chip system, or a processor, etc., that supports the terminal device to implement the method, and may further be a chip, a chip system, or a processor, etc., that supports the terminal device to implement the method. The communication apparatus may be used to implement the methods described in the method examples, which may refer to the description in the method examples for details.

The communication apparatus 800 may include one or more processors 801. The processor 801 may be a general purpose processor or a specialized processor, etc. It may be, for example, a baseband processor or a central processing unit. The baseband processor may be used for processing a communication protocol and communication data, and the central processing unit may be used for controlling a communication apparatus (e.g., a base station, a baseband chip, an electronic device, an electronic device chip, a DU or a CU, etc.) to execute a computer program and process data from the computer program.

Alternatively, one or more memories 802 may also be included in the communication apparatus 800 on which a computer program 803 may be stored, and the processor 801 executes the computer program 803 to enable the communication apparatus 800 to perform the methods described in the method examples above. Alternatively, data may also be stored in the memory 802. The communication apparatus 800 and the memory 802 may be arranged separately or may be integrated together.

Alternatively, the communication apparatus 800 may also include a transceiver 804, and an antenna 805. The transceiver 804 may be referred to as a receive-send unit, a transceiver, or a receive-send circuit, etc., and is used for implementing a receive-send function. The transceiver 804 may include a receiver and a sender, the receiver may be referred to as a receiving machine or receiving circuit, etc., for implementing a receiving function, and the sender may be referred to as a sending machine or sending circuit, etc., for implementing a sending function.

Alternatively, one or more interface circuits 806 may also be included in the communication apparatus 800. The interface circuit 806 is used to receive code instructions and transmit them to processor 801. The processor 801 runs the code instruction to enable the communication apparatus 800 to perform the method described in the method example.

When the communication apparatus 800 is a network-side device in the preceding method example, the processor 801 is configured to perform step S201 in FIG. 2, step S301 and step S302 in FIG. 3, step S401 and step S402 in FIG. 4, and step S501, step S502, and step S503 in FIG. 5, the transceiver 804 is configured to perform step S202 and step S203 in FIG. 2.

When the communication apparatus 800 is a terminal device in the foregoing method example, the processor 801 is configured to perform step S602 in FIG. 6, the transceiver 804 is configured to perform step S601 and step S603 in FIG. 6.

In an implementation, the processor 801 may include a transceiver for implementing receiving and sending functions. For example, the transceiver may be a transceiving circuit, or an interface, or an interface circuit. The transceiving circuit, interface or interface circuit used for implementing the receiving and transmitting functions may be separate or integrated together. These receive-send circuit, interface or interface circuit may be used for reading and writing of a code/data, or these receive-send circuit, interface or interface circuit may be used for transmitting or passing of a signal.

In an implementation, the processor 801 may store a computer program, and the computer program is run on the processor 801 and may enable the communication apparatus 800 to perform any one of the methods described in the method examples. The computer program may be solidified in the processor 801, in which case the processor 801 may be implemented by hardware.

In an implementation, the communication apparatus 800 may include a circuit, and the circuit may implement the function of sending or receiving or communicating in the foregoing method examples. The processor and transceiver described in the disclosure may be implemented on an integrated circuit (IC), an analog IC, a radio frequency integrated circuit (RFIC), a mixed signal IC, an application specific integrated circuit (ASIC), a printed circuit board (PCB), a communication apparatus, and the like. The processor and the transceiver may also be fabricated using a variety of IC process technologies, such as a complementary metal oxide semiconductor (CMOS), an nMetal-oxide-semiconductor (NMOS), a positive channel metal oxide semiconductor (P-type metal oxide semiconductor, PMOS), a bipolar junction transistor (BJT), a bipolar CMOS (BiCMOS), silicon germanium (SiGe), gallium arsenide (GaAs), and so on.

The communication apparatus in the description of the example may be a network side device or a terminal device, but the scope of the communication apparatus described in the disclosure is not limited to this, and the structure of the communication apparatus may not be limited by FIG. 8. The communication apparatus may be a separate device or may be part of a larger device. For example, the communication apparatus may be: (1) a separate integrated circuit (IC), or chip, or, a chip system or subsystem; (2) a set having one or more ICs, alternatively, the set of ICs may also include a storage component for storing data and a computer program; (3) an ASIC, such as a modem; (4) a module that may be embedded within other devices; (5) a receiver, a terminal device, an intelligent terminal device, a cellular phone, a wireless device, a handset, a mobile unit, an in-vehicle device, a network device, a cloud device, an artificial intelligence device, etc.; and (6) other, etc.

Those skilled in the art may further appreciate that various illustrative logical blocks and steps set forth in the examples of the disclosure may be implemented by electronic hardware, computer software, or a combination of the two. Whether such a function is implemented by hardware or software depends on a specific application and design requirements of an overall system. Those skilled in the art may, for each specific application, use various methods to implement the described function, but such implementation is not to be construed as being beyond the scope of protection of the examples of the disclosure.

An example of the disclosure further provides a communication system. The system includes a communication apparatus as a network-side device and a communication apparatus as a terminal device in the foregoing example of FIG. 7, or, the system includes a communication apparatus as a network-side device and a communication apparatus as a terminal device in the foregoing example of FIG. 8.

The disclosure further provides a non-transitory readable storage medium on which an instruction is stored. When executed by a computer, the instruction implements the function of any one of the method examples.

The disclosure further provides a computer program product. When executed by a computer, the computer program product implements the function of any one of the method examples.

In the example, the function may be implemented in whole or in part by software, hardware, firmware, or any combination of them. When implemented by using software, the function may be implemented in whole or in part in the form of the computer program product. The computer program product includes one or more computer programs. When the computer program is loaded and executed on a computer, the process or function described according to the examples of the disclosure is generated in whole or in part. The computer may be a general-purpose computer, a specialized computer, a computer network, or other programmable apparatuses. The computer program may be stored in a non-transitory computer readable storage medium or transmitted from one non-transitory computer readable storage medium to another non-transitory computer readable storage medium. For example, the computer program may be transmitted from one website, computer, server, or data center to another website, computer, server, or data center by wired (e.g., a coaxial cable, optical fiber, and digital subscriber line (DSL)) or wireless (e.g., infrared, wireless, microwave, etc.) means. The non-transitory computer readable storage medium may be any available medium to which a computer can access or a data storage device such as a server, data center, etc., that contains one or more available medium integrations. The available medium may be a magnetic medium (e.g., a floppy disk, a hard disk, and a tape), an optical medium (e.g., a high-density digital video disc (DVD)), or a semiconductor medium (e.g., a solid state disk (SSD)), etc.

Those ordinarily skilled in the art may understand that first, second, and various other numerical numbers involved in the disclosure are merely distinguished for descriptive convenience, are not used for limiting the scope of the examples of the disclosure, and also indicate the order of precedence.

At least one in the disclosure may also be described as one or more, and a plurality may be two, three, four, or more, without limitation of the disclosure. In the examples of the disclosure, for a technical feature, technical features in the technical feature are distinguished by “first,” “second,” “third,” “A,” “B,” “C,” “D,” etc. There is no order of precedence or magnitude among the technical features described in “first,” “second,” “third,” “A,” “B,” “C” and “D”.

Correspondences shown in tables in the disclosure may be configured or may be predefined. Values of information in the tables are merely examples and may be configured to other values, which is not limited by the disclosure. When a correspondence between information and each parameter is configured, it is not necessarily required that all correspondences illustrated in each table must be configured. For example, the correspondence illustrated in certain rows of the tables in the disclosure may also be unconfigured. As another example, appropriate distortion adjustments may be made based on the table, e.g., splitting, merging, etc. Names of parameters shown in headings in the tables may also be other names understandable by the communication apparatus, and values or representations of the parameters of which may also be other values or representations understandable by the communication apparatus. Each of the tables may also be implemented with other data structures. For example, an array, a queue, a container, a stack, a linear table, a pointer, a chained table, a tree, a graph, a structure, a class, a heap, a hash table, or a hash table, etc. may be used.

Predefining in the disclosure may be understood as defining, defining in advance, storing, pre-storing, pre-negotiating, pre-configuring, curing, or pre-firing.

Those ordinarily skilled in the art may realize that units and algorithmic steps of the various examples described in conjunction with the examples disclosed here may be implemented with electronic hardware, or a combination of computer software and electronic hardware. Whether these functions are performed in a form of hardware or software depends on the specific application and design constraints of the technical solutions. Those skilled in the art may use different methods to implement the described functions for each specific application, but such implementation is not considered to be beyond the scope of the disclosure.

It is clearly understood by those skilled in the art to which it belongs that, for the convenience and brevity of the description, the specific work processes of the systems, apparatuses, and units described can refer to the corresponding processes in the foregoing method examples, which will not be repeated here.

The above is merely the specific implementations of the disclosure, but the scope of protection of the disclosure is not limited to this. Changes or replacements that can be easily thought of by those skilled in art within the technical scope disclosed in the disclosure are to be covered in the scope of protection of the disclosure. Thus, the scope of protection of the disclosure is to be subject to the scope of protection of the claims.

1. A method for sending a reference signal performed by a network-side device, the method comprising:
determining reference signal configuration information;
sending the reference signal configuration information, wherein the reference signal configuration information is used for indicating direction information of a reference signal; and
sending the reference signal based on the reference signal configuration information; wherein the reference signal is used for indicating a terminal device to perform beam measurement and/or beam management.

2. The method according to claim 1, wherein the reference signal configuration information comprises at least one of:
an index of each reference signal in a configured reference signal set;
an index of a configured datum reference signal;
a beam width of each reference signal in the configured reference signal set; or
an interval angle between sending beams of reference signals of adjacent indexes in the configured reference signal set.

3. The method according to claim 2, wherein the interval angle comprises an interval angle of a first dimension and/or an interval angle of a second dimension; wherein
the interval angle of the first dimension is an interval angle of a center of a beam in the first dimension, and the interval angle of the second dimension is an interval angle of a center of a beam in the second dimension;
or, the interval angle of the first dimension is an interval angle of a boundary of the beam in the first dimension, and the interval angle of the second dimension is an interval angle of a boundary of the beam in the second dimension.

4. The method according to claim 2, wherein determining the index of each reference signal in the configured reference signal set comprises:
determining a component index value of a first dimension of each reference signal in the configured reference signal set sequentially in the first dimension according to a positive direction or a negative direction by using a datum direction as a starting direction and the interval angle of the first dimension as a step size; or, determining a component index value of a second dimension of each reference signal in the configured reference signal set sequentially in the second dimension according to the positive direction or the negative direction by using the datum direction as a starting direction and the interval angle of the second dimension as a step size; and
determining the index of each reference signal in the configured reference signal set according to the component index value of the first dimension of each reference signal and/or the component index value of the second dimension of each reference signal.

5. The method according to claim 4, wherein
the datum direction is a beam direction of the configured datum reference signal;
or, the datum direction is a preset absolute direction.

6. The method according to claim 4, wherein a sending beam of each reference signal is a one-dimensional beam; and determining the index of each reference signal in the configured reference signal set according to the component index value of the first dimension of each reference signal or the component index value of the second dimension of each reference signal comprises:
determining the component index value of the first dimension of each reference signal or the component index value of the second dimension of each reference signal as the index of each reference signal.

7. The method according to claim 4, wherein a sending beam of each reference signal is a two-dimensional beam; and determining the index of each reference signal in the configured reference signal set according to the component index value of the first dimension of each reference signal and the component index value of the second dimension of each reference signal comprises:
generating the index of each reference signal according to the component index value of the first dimension of each reference signal and the component index value of the second dimension of each reference signal.

8. The method according to claim 7, wherein generating the index of each reference signal according to the component index value of the first dimension of each reference signal and the component index value of the second dimension of each reference signal comprises:
generating the index of each reference signal according to the component index value of the first dimension of each reference signal, a number of beams in the first dimension, and the component index value of the second dimension of each reference signal; or,
generating the index of each reference signal according to the component index value of the first dimension of each reference signal, the component index value of the second dimension of each reference signal, and a number of beams in the second dimension.

9. The method according to claim 4, further comprising:
determining a configuration mode of an index of the reference signal, wherein the configuration mode of an index of the reference signal is the configuration mode adopted when the index of each reference signal is configured;
wherein the reference signal configuration information further comprises the configuration mode of an index of the reference signal.

10. A method for receiving a reference signal performed by a terminal device, the method comprising:
receiving reference signal configuration information; wherein the reference signal configuration information is used for indicating direction information of a reference signal;
determining the direction information of the reference signal according to the reference signal configuration information and a configuration mode of an index of the reference signal; and
receiving the reference signal based on the direction information of the reference signal; wherein the reference signal is used for indicating the terminal device to perform beam measurement and/or beam management.

11. The method according to claim 10, wherein the reference signal configuration information comprises at least one of:
an index of each reference signal in a configured reference signal set;
an index of a configured datum reference signal;
a beam width of each reference signal in the configured reference signal set; or
an interval angle between sending beams of reference signals of adjacent indexes in the configured reference signal set.

12. The method according to claim 11, wherein the interval angle comprises an interval angle of a first dimension and/or an interval angle of a second dimension; wherein
the interval angle of the first dimension is an interval angle of a center of a beam in the first dimension, and the interval angle of the second dimension is an interval angle of a center of a beam in the second dimension; or,
the interval angle of the first dimension is an interval angle of a boundary of the beam in the first dimension, and the interval angle of the second dimension is an interval angle of a boundary of the beam in the second dimension.

13. The method according to claim 10, wherein
the configuration mode of an index of the reference signal is the configuration mode agreed by a protocol;
or, the configuration mode of an index of the reference signal is contained in the reference signal configuration information.

14.-26. (canceled)

27. A communication apparatus, comprising:
one or more processors and one or more memories, wherein a computer program is stored in the one or more memories, and the computer program, when executed by the one or more processors, causes the communication apparatus to:
determine reference signal configuration information;
send the reference signal configuration information, wherein the reference signal configuration information is used for indicating direction information of a reference signal; and
send a corresponding reference signal based on the reference signal configuration information; wherein the corresponding reference signal is used for indicating a terminal device to perform beam measurement and/or beam management.

28. A communication apparatus, comprising one or more processors and one or more memories, wherein a computer program is stored in the one or more memories, and the computer program, when executed by the one or more processors, causes the communication apparatus to perform the method according to claim 10.

29. A communication apparatus, comprising:
one or more processors; and
one or more interface circuits; wherein
the one or more interface circuits are configured to receive a code instruction and transmit the code instruction to the one or more processors; and
the one or more processors are configured to run the code instruction, wherein the code instructions cause the communication apparatus to act as the network-side device and perform the method according to claim 1.

30. A communication apparatus, comprising:
one or more processors; and
one or more interface circuits; wherein
the one or more interface circuits are configured to receive a code instruction and transmit the code instruction to the one or more processors; and
the one or more processors are configured to run the code instruction, wherein the code instructions cause the communication apparatus to act as the terminal device and perform the method according to claim 10.

31. A non-transitory computer readable storage mediums storing an instruction that when executed by the network-side device cause the network-side device to perform the method according to claim 1.

32. A non-transitory computer readable storage medium storing an instruction that when executed by the terminal device cause the terminal device to perform the method according to claim 10.

33. The method according to claim 4, wherein a sending beam of each reference signal is a two-dimensional beam; and determining the index of each reference signal in the configured reference signal set according to the component index value of the first dimension of each reference signal and the component index value of the second dimension of each reference signal comprises:
determining the component index value of the first dimension of each reference signal and the component index value of the second dimension of each reference signal as the index of each reference signal.
